(19) United States
(12) Patent Application Publication
(10) Pub. No.: US 2026/0141735 A1
(43) Pub. Date: May 21, 2026

(54) EVENT-BASED DRIVER MOTION RECOGNITION SYSTEM USING CONVOLUTION SPIKING NEURAL NETWORK ON LOIHI 2 FOR AUTONOMOUS DRIVING

(71) Applicant: SUNY Korea Research and Business Development Foundation, Incheon (KR)

(72) Inventors: Yoon Seok YANG, Incheon (KR); Byungkon KANG, Suwon-si, Gyeonggi-do (KR); Hyo Jong CHUNG, Seoul (KR)

(73) Assignee: SUNY Korea Research and Business Development Foundation, Incheon (KR)

(21) Appl. No.: 19/394,138

(22) Filed: Nov. 19, 2025

(30) Foreign Application Priority Data
Nov. 20, 2024 (KR) 10-2024-0166263
Jan. 16, 2025 (KR) 10-2025-0006482

(51) Int. Cl. G06V 20/59; G06N 3/084; G06V 10/82

(52) U.S. Cl. CPC G06V 20/597; G06N 3/084; G06V 10/82

(57) ABSTRACT

Provided is an event-based driver motion recognition system using a Loihi 2-based convolutional spiking neural network for autonomous driving, and provided are an N-Driver Motion being a vision system and an event-based dataset for neuromorphic learning and driver motion prediction based on an efficient convolutional spiking neural network (CSNN).

### CROSS-REFERENCE TO RELATED APPLICATIONS

A claim for priority under 35 U.S.C. § 119 is made to Korean Patent Application Nos. 10-2024-0166263 filed on Nov. 20, 2024 and 10-2025-0006482 filed on Jan. 16, 2025 in the Korean Intellectual Property Office, the entire contents of which are hereby incorporated by reference.

### BACKGROUND

Embodiments of the present disclosure described herein relate to an event-based driver motion recognition system using a Loihi 2-based convolutional spiking neural network for autonomous driving, and more particularly, relate to a driver motion recognition technology using an event-based camera and a spiking neural network. This invention was made as part of the project titled “Regional Intelligence Innovation Talent Development Program (Inha University)”, supported by the Ministry of Science and ICT through the Institute of Information & Communications Technology Planning & Evaluation (IITP) under Project No. 2710070131. The project was conducted by the Research Cooperation Foundation of The State University of New York, Korea, with a 100% contribution rate, and covers the total research period from Jul. 1, 2023, to Dec. 31, 2030.

With the development of artificial intelligence (AI), the AI is being applied to various industries, and automotive AI systems are emerging as one of the most prominent applications. In-vehicle AI systems are integrated with a control system and are used to support autonomous driving and to ensure the safety of a driver and a pedestrian. In particular, the European Union (EU) and the United States have introduced mandatory requirements for various driver assistance systems through the General Motor Vehicle Safety Regulation to ensure the safety of road traffic. The main goal of these regulations is to increase the protection of older drivers, vehicle occupants, pedestrians, and cyclists. According to research, 95% of traffic accidents are caused by human errors, and the implementation of these regulations is expected to save more than 25,000 lives and to prevent at least 140,000 serious injuries by 2038. Against this backdrop, there is an urgent need for research and development of advanced driver assistance systems (ADAS) using the AI.

Conventional AI vision systems for autonomous driving utilize AI platforms by sending information trained from large data sets to individual vehicles. These systems are typically implemented with GPU or AI accelerator-based hardware for data learning and inference, which causes issues such as high power consumption, slow response time, and difficulty in making real-time predictions.

These issues are exacerbated by the exponential growth in neural network computation required to process the massive training data sets needed for autonomous driving. To address these issues, next-generation AI vision systems with low power, high performance, and high efficiency are expected to be pivotal to the AI realization of autonomous driving.

In particular, neuromorphic AI vision systems are attracting attention as an important way to support AI technology for autonomous driving. Neuromorphic cameras, also known as “event cameras,” and neuromorphic processors, which mimic the functions of the human eye and brain, offer ultra-low power consumption, high efficiency, and fast responsiveness. These technologies are actively being applied in a variety of applications as key components to meet the sensing and processing requirements of autonomous vehicles.

### SUMMARY

Embodiments of the present disclosure provide an N-Driver Motion being a vision system and an event-based dataset for neuromorphic learning and driver motion prediction based on an efficient convolutional spiking neural network (CSNN).

Embodiments of the present disclosure provide a neuromorphic framework for configuring CSNN, which is efficient in terms of energy and latency through driver motion recognition research, and implement a driver safety assistance function by integrating high-resolution event-based cameras.

Embodiments of the present disclosure provide a first driver motion recognition study using a high-resolution event camera and a spiking neural network (SNN) by generating an event-based dataset, which is called N-Driver Motion (resolution 720×720), for large-scale driver motion recognition.

Embodiments of the present disclosure provide 13 driver motion categories based on front and side directions, lighting conditions (bright, moderate, and dark), and participants, through an event-based dataset.

Embodiments of the present disclosure provide a simplified 4-layer CSNN.

Embodiments of the present disclosure propose a novel simplified 4-layer CSNN capable of being trained by directly using an event dataset without time-consuming preprocessing, thereby efficiently adapting it to an on-device SNN for real-time inference on an event-based camera stream.

Embodiments of the present disclosure design an efficient CSNN for an Intel Lava neuromorphic framework and a Loihi 2 processor.

Embodiments of the present disclosure design an efficient CSNN optimized for the Intel Lava neuromorphic framework, which is one of the widely used and practical neuromorphic frameworks for driver motion recognition, and propose a CSNN version suitable for the Loihi 2 processor.

However, the issues to be solved according to an embodiment are not limited to those mentioned above.

According to an embodiment, a driver motion recognition device includes a memory that stores at least one instruction for event-based driver motion recognition by using a Loihi 2-based convolutional spiking neural network (CSNN) for autonomous driving, and a processor that performs an operation according to the instruction. The processor generates an event-based driver motion dataset for training and verifying a Loihi 2 chip-based CSNN by recording event data of a specific resolution during a specific period of time by using a camera. The Loihi 2 chip-based CSNN is a 4-layer CSNN model consisting of a 3D pooling layer, a 3D convolution layer, and two fully connected layers, and recognizes a real-time driver motion through event-based data processing method and a fast computational speed of a Loihi 2 chip.

Moreover, the dataset may include event data including information about an x-coordinate, an y-coordinate, a polarity, and an occurrence time, and may include 13 driver motions including one normal driving motion and twelve potentially-hazardous motions, 23 participants, and a lighting condition including bright, moderate, and dark.

Furthermore, the processor may evaluate generalization performance of the Loihi 2 chip-based CSNN by including five types of abnormal event data that are not used in training.

Also, the 3D pooling layer of the CSNN model may reduce a size of input event data by using an 8×8 kernel and may reduce memory usage. The 3D convolution layer of the CSNN model may generate a feature map of 16 channels by using a 5×5 kernel.

The fully connected layer of the CSNN model may generate a spike rate for each class of 13 output nodes through the two fully connected layers.

Besides, the CSNN may train a CSNN model with an N-Driver Motion dataset by using a surrogate gradient descent (SLAYER)-based backpropagation method.

In addition, the processor may generate event data as a dataset by detecting a change amount of light, and may provide a temporal resolution, at which each pixel is capable of operating in a single frame, through the dataset.

Moreover, the 13 driver motions may include tilting a head to a side, tilting the head forward, tilting the head backward, using a mobile phone with a right hand, using the mobile phone with a left hand, looking back to a right, looking back to a left, bending down to a right, and bending down to a left.

Furthermore, the abnormal event data may include a seizure during driving, sudden standing, a collision where a driver hits a windshield, a hand-swipe gesture, and an abnormal camera angles due to an accident or a camera fixation issue.

Also, the CSNN may be built based on a spiking neural network (SNN) and may directly train a CSNN model by converting event data into a spike form.

Besides, the CSNN may perform a 3D spiking convolution operation by using spatial information and time information of the event data.

According to an embodiment, a driver motion recognition method of an event-based driver motion recognition device using a Loihi 2 chip-based CSNN for autonomous driving includes generating an event-based driver motion dataset for training and verifying the Loihi 2 chip-based CSNN by recording event data of a specific resolution during a specific period of time by using a camera, configuring the Loihi 2 chip-based CSNN as a 4-layer CSNN model consisting of a 3D pooling layer, a 3D convolution layer, and two fully connected layers, and recognizing a real-time driver motion through an event-based data processing method and a fast computational speed of a Loihi 2 chip.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a diagram illustrating simplified architecture of Loihi showing how a neurocore is configured and operates;

FIG. 2 illustrates a 3D convolution spiking operation, according to an embodiment;

FIG. 3 is a diagram illustrating a proposed event-based driver gesture recognition system;

FIG. 4 is a diagram showing a sample image captured for each driver gesture;

FIG. 5 shows a table showing a label (a) of driver gestures and abnormal driver gestures (b);

FIG. 6 shows sample images captured for abnormal driver gestures;

FIG. 7 is a table illustrating a network configuration of a four-layer CSNN for a GPU;

FIG. 8 is a table illustrating neuron parameter settings;

FIG. 9 illustrates a pipeline for inference of CSNN on a Loihi 2 processor;

FIG. 10 is a table illustrating resource utilization of a 3-layer fully connected layer model on Loihi 2;

FIG. 11 is a table illustrating resource utilization on Loihi 2 of the proposed CSNN model;

FIG. 12 is a diagram showing results of the 3-layer fully connected layer SNN (3FC) and the proposed CSNN (PK=8 and a pooling kernel size of PK=18), according to an embodiment;

FIG. 13 a table for comparing classification results of a DVS Gesture dataset and an N-Driver Motion dataset;

FIG. 14 is a diagram illustrating the classification results for 13 driver motions through output spikes captured in an output layer;

FIG. 15 is a diagram illustrating the classification results for unexpected abnormal driver motions;

FIG. 16 shows a table illustrating the results of a comparison between GPU and Loihi 2 for single-sample inference costs;

FIG. 17 is a block diagram illustrating a computing environment 10 including a computing device suitable for use, in embodiments; and

FIG. 18 is a flowchart illustrating a driver motion recognition method of an event-based driver motion recognition device using a Loihi 2-based convolutional spiking neural network for autonomous driving.

### DETAILED DESCRIPTION

Hereinafter, various embodiments of the present disclosure will be described to be associated with accompanying drawings. While various embodiments of the present disclosure are susceptible to various modifications and have several embodiments, specific embodiments thereof are shown by way of example in the drawings and detailed descriptions thereof will be described. It should be understood, however, that there is no intent to limit the various embodiments of the present disclosure to the particular forms disclosed, but on the contrary, the present disclosure is to cover all modifications, equivalents, and alternatives falling within the spirit and scope of the various embodiments of the present disclosure. With regard to description of drawings, similar elements may be marked by similar reference numerals.

It will be further understood that the terms “comprises,” “comprising,” “includes,” and/or “including,” when used in the various embodiments of the present disclosure, specify the presence of stated features, numbers, steps, operations, elements, components, or groups thereof, but do not preclude the presence or addition of one or more other features, numbers, steps, operations, elements, components, and/or groups thereof.

In various embodiments of the present disclosure, the expressions of “or” may include one or all combinations of the associated listed words. For example, a term “A or B” may include all of the case (1) where ‘A’ is included, the case (2) where ‘B’ is included, or the case (3) where both of ‘A’ and ‘B’ are included.

The terms, such as “first”, “second”, and the like used in various embodiments of the present disclosure may refer to various elements of various embodiments, but do not limit the corresponding components. For example, the expressions do not limit the order and/or importance of the corresponding components, and may be used to distinguish one component from another component.

It will be understood that when an element is referred to as being “connected” or “coupled” to the other element, the element may be directly connected or coupled to the other element or another new elements may be present between the element and the other element.

In an embodiment of the present disclosure, terms such as a “module,” a “unit,” a “part,” etc. are terms used to refer to a component that performs at least one function or operation, and the component may be implemented as hardware or software, or as the combination of hardware and software. Moreover, a plurality of “modules,” “units,” “parts,” etc. may be integrated into at least one module or chip and may be implemented as at least one processor, except that each of them needs to be implemented as individual specific hardware.

It will be understood that terms used herein should be interpreted as having a meaning that is consistent with their meaning in the context of the present disclosure and the relevant art and will not be interpreted in an idealized or overly formal sense unless expressly so defined in the various embodiments of the present disclosure.

Below, embodiments of the present disclosure will be described in detail with reference to accompanying drawings.

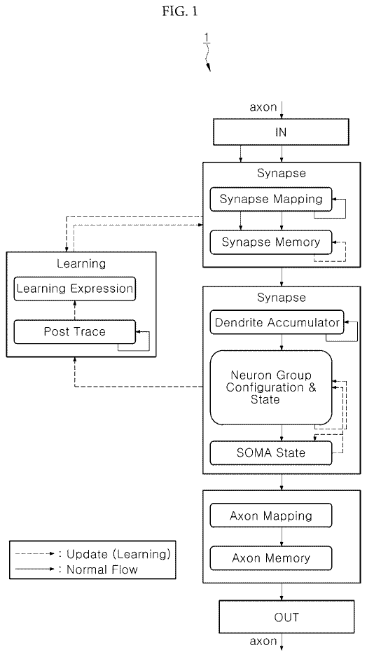

FIG. 1 is a diagram illustrating simplified architecture of Loihi showing how a neurocore is configured and operates. According to an embodiment, an event-based driver motion recognition system using Loihi 2-based convolutional spiking neural network for autonomous driving generates an event-based dataset N-Driver Motion with a resolution of 720×720. In an embodiment, the driver motion recognition system generates N-Driver Motion, which is an event-based dataset for large-scale driver motion recognition, by using an event-based camera. It is known as the first study for recognizing a driver motion by using a high-resolution event camera and a SNN. The event-based dataset is categorized into 13 driver motion categories based on a direction (a front or a side), lighting (bright, moderate, or dark), and a participant. Furthermore, a novel simplified 4-layer CSNN is proposed. In an embodiment, the novel 4-layer CSNN capable of being trained directly with the event-based dataset without time-consuming preprocessing is proposed. This enables efficient adaptation to an on-device SNN capable of real-time inference on an event-based camera stream. Furthermore, the proposed neuromorphic vision system achieved the accuracy of 94.04% in a 13-class classification task and the accuracy of 97.24% in an unexpected and abnormal driver motion classification task.

The driver motion recognition system according to an embodiment plays an important role in developing safe and efficient driver monitoring systems for autonomous vehicles and edge devices requiring low-power and efficient neural network architectures. In an embodiment, a CSNN optimized for the Intel Lava neuromorphic framework and Loihi 2 is designed in a driver motion recognition system, and an efficient CSNN is designed to be suitable for the Intel Lava framework, which is a neuromorphic framework widely used for driver motion recognition.

Moreover, a CSNN version suitable for the Loihi 2 processor is proposed. The result of measuring an energy-delay product (EDP) on Loihi 2 indicates that it is 20,721 times more efficient than a non-edge GPU and 541 times more efficient than an edge GPU.

Furthermore, in an embodiment, the results of the driver motion recognition system have significant meanings for energy efficiency, which is one of the most important factors in an edge AI. An optimized CSNN for energy efficiency and on-device application distribution is designed. Furthermore, in an embodiment, the optimized CSNN that is energy efficient and is capable of being distributed in on-device applications and systems (e.g., Loihi 2) is designed. In an embodiment, to train the proposed CSNN, an N-Driver Motion dataset is directly trained by using SLAYER, which is a surrogate gradient descent-based backpropagation method. Also, in an embodiment, instead of directly resizing high-resolution event frames, a pooling layer is added such that adaptive deployment is possible in GPUs and Loihi 2 systems based on memory requirements.

In an embodiment, an N-Driver Motion, which is an event-based dataset, using an event-based camera (the resolution of 720×720) for large-scale driver motion recognition is created. This is the first study on driver motion recognition by using high-resolution event cameras and an SNN.

The N-Driver Motion dataset provided in an embodiment is obtained by categorizing the driver's motions into 13 categories, and the classification criteria are divided depending on a direction (a front or a side), lighting (bright, moderate, or dark), and a participant.

Furthermore, in an embodiment, a novel simplified four-layer CSNN is proposed, and the network is directly trained with the event dataset without any preprocessing. This enables real-time inference on an event-based camera stream and efficient adaptation to SNNs on edge devices. In an embodiment, the proposed neural network achieves the accuracy of 94.04% in a 13-motion class classification task and the accuracy of 97.24% in an unexpected and abnormal driver motion classification task. This provides a safe and efficient solution for a driver monitoring system in autonomous vehicles or low-power edge devices.

Moreover, in an embodiment, a CSNN suitable for the Intel Lava neuromorphic framework is provided. Furthermore, a CSNN version suitable for a Loihi 2 processor of Intel is proposed. As a result, it is observed that the EDP of the proposed model on Loihi 2 is 20,721 times more efficient than non-edge GPUs and 41 times more efficient than edge GPUs. This is considered as a critical factor in an edge device AI.

Furthermore, in an embodiment, a CSNN optimized for energy efficiency and distribution on edge devices such as Loihi 2 is designed. To train the proposed CSNN, the N-Driver Motion dataset is directly trained by using a surrogate gradient descent-based backpropagation method called SLAYER. Also, in an embodiment, instead of directly resizing a high-resolution event frame, a pooling layer is added such that adaptive distribution to the GPU and Loihi 2 system depending on memory requirements is possible.

### Event-Based Driver Motion Recognition System

In an embodiment, an efficient CSNN architecture, a driver motion learning and a prediction system are presented. This system utilizes a direct training mechanism and an event-based data stream. Unlike static images, event-based data includes time information to represent events, and thus an efficient CSNN model is built by adopting a direct spiking training method and a 3D spike convolution operation.

### Direct Training of Spiking Neural Network

In an embodiment, a gradient-based training method is used to directly train an SNN. It is well known that differentiating the SNN is difficult due to the characteristics of discrete spike events. To address this issue, approximation methods for differentiating a spike function is proposed in several studies. However, previous studies failed to address this issue in consideration of the temporal dispersion between spikes.

Accordingly, in an embodiment, a differentiable approximation for the differentiating the spike function is proposed. This approximation relates to the probability of a spiking state change. The differentiating of the spike function is described as a probability density function (PDF) of the state change of the spiking neuron.

$${∇}_{{W}^{( l )}} E = {\int }_{0}^{T} {δ}^{( l + 1 )} ( t ) \cdot {( {a}^{( l )} ( t ) )}^{T} dt \qquad [ Equation 1 ]$$

$${∇}_{{d}^{( l )}} E = - {\int }_{0}^{T} {\dot{a}}^{( l )} ( t ) \cdot {e}^{( l )} ( t ) dt \qquad [ Equation 2 ]$$

$${e}^{( l )} = \{ \begin{matrix}\frac{\partial L ( t )}{\partial {a}^{( {n}_{l} )}} & if l = {n}_{l} \\ {( {W}^{( l )} )}^{T} {δ}^{( l + 1 )} ( t ) & otherwise\end{matrix} \qquad [ Equation 3 ]$$

$${δ}^{( l )} ( t ) = {ρ}^{( l )} ( t ) \cdot ( {ε}_{d} ⊙ {e}^{( l )} ) ( t ) \qquad [ Equation 4 ]$$

ρ^{(l)}(t) represents a probability density function (PDF) at a specific time ‘t’ in a layer ‘l’. Δε represents random perturbation. W^{(l)} is a weight vector of the layer ‘l’. a^{(l)} represents a spike response signal. L(t) represents the loss at the specific time ‘t’. d^{(l)} represents an axonal delay. ε_{d} represents a spike response kernel. ⊙ represents an element-wise correlation operation over time.

Similarly to a deep neural network (DNN), this method effectively backpropagates errors through layers of a neural network. Errors of previous time periods are considered in this process, which is an important factor because the state of a spiking neuron depends on its previous state.

In the model provided in an embodiment, an event-based video stream is defined as a 3D tensor of a form of (u, v, t). Here, ‘u’ and ‘v’ represent the coordinates corresponding to the width and the height of the layer ‘l’, and ‘t’ operates as a timestamp. Furthermore, a user may control ‘t’ in an original segment by configuring an optimal temporal frequency.

### Convolutional Neural Network (CNN) and Event-Based Video

A CNN is a feedforward network consisting of multiple layers, where a filter performs a convolution operation depending on an input or a single layer such that a neuron is capable of collecting a meaningful feature or pattern.

However, an event-based video includes not only spatial information but also time information. Accordingly, a 3D convolution kernel is required to build a spiking neuron feature map by using a sampled input sequence S (n).

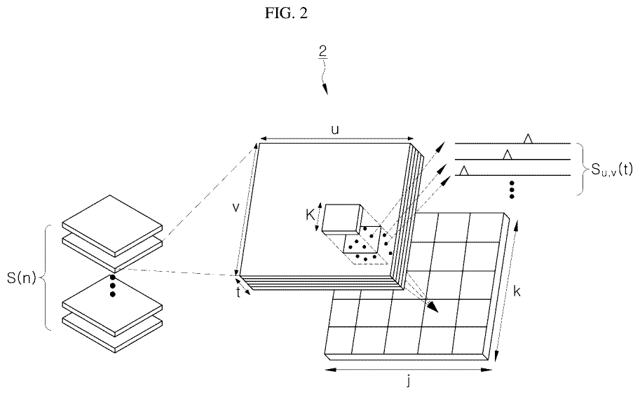

FIG. 2 illustrates a 3D convolution spiking operation, according to an embodiment. As illustrated in FIG. 2, each spike within a kernel is represented as a cluster of spike trains, Su,v(t). The coordinates of a spike are represented as (u, v), which fall within a temporal resolution window ‘t’.

A spike generated within the kernel is continuously accumulated by neurons in a feature map. When the spike in a kernel region exceeds a certain threshold, a membrane potential is generated for a single neuron in the feature map. In this way, a spatio-temporal dynamic pattern is created.

### 3D Spiking Convolution Operation

A 3D spiking convolution operation is performed by performing a convolution operation on a spike train within a kernel, applying a spike response kernel, and then applying a threshold function. Each spike train is converted into a spike response signal, and is then integrated with the neuron's refractory response so as to be converted to a membrane potential. This approach captures a dynamic spiking pattern over time and extracts important features based on spike firing and accumulation of the neuron's membrane potential.

$${a}_{u , v} ( t ) = {S}_{u , v} ( t ) * {ε}_{d} ( t ) \qquad [ Equation 5 ]$$

$${u}_{j , k} ( t ) = {\sum }_{m = 1}^{K} {\sum }_{n = 1}^{K} {W}_{m , n} {a}_{m + ( j - 1 ) , n + ( k - 1 )} ( t ) + ( {S}_{j , k} ( t ) * ν ( t ) ) \qquad [ Equation 6 ]$$

$${S}_{j , k} ( t ) = 1 and {u}_{j , k} ( t ) = 0 when {u}_{j , k} ( t ) \geq {V}_{thr} \qquad [ Equation 7 ]$$

Here, * represents a convolution operator. W_{m,n} represents the synaptic weight at a location (m, n) of a kernel. u_{j,k} represents a membrane potential at coordinate (j, k) in a feature map. ‘K’ represents the width and the height of a convolution kernel. v(t) represents a refractory kernel. Vₜₕᵣ represents a membrane potential threshold. In an embodiment, the proposed model is developed based on a conventional model that implements SNN training and 3D spike convolution operations for Dynamic Vision Sensor (DVS) gesture recognition.

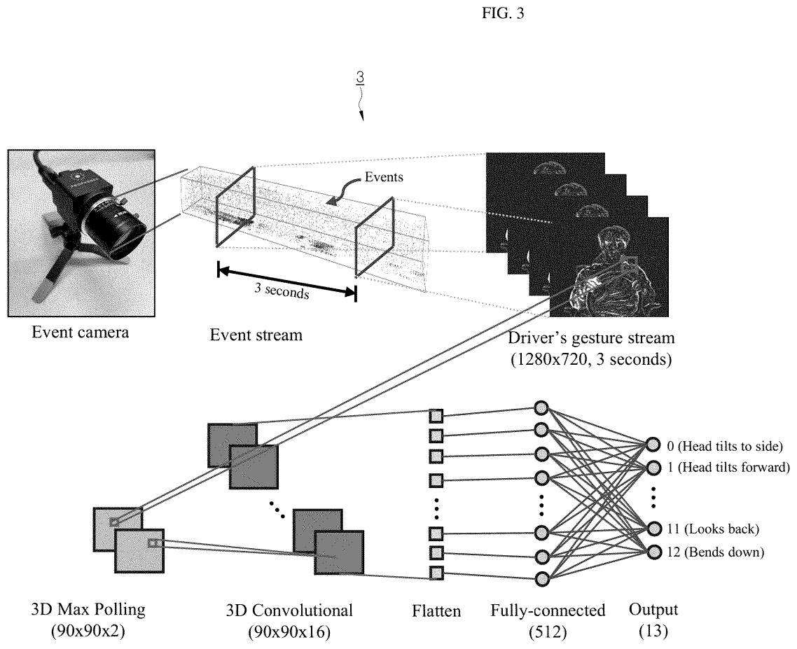

A conventional SLAYER and a TrueNorth model consist of 8 layers and 16 layers, respectively. FIG. 3 is a diagram illustrating a proposed event-based driver gesture recognition system. Referring to FIG. 3, an event stream is captured by an EVK4 camera; the length of each event is 3 seconds; this stream is input to the proposed model; and, the input is sampled every 2 seconds. The model classifies a stream based on an event rate and selects a class with the most spikes as the classification result. However, as shown in FIG. 3, the proposed network model and system are simplified to only four layers.

Testing with a complex model indicates that a performance degradation that lowers an event rate occurs by interfering with the firing of spikes in the neurons in addition to taking up more memory. This results in spikes not being propagated to successive neuron layers.

### Event-Based Driver Motion Recognition System

For driver motion recognition, an event stream of 720×720 resolution is recorded for 3 seconds by using an event-based camera and is delivered to a first 3D pooling layer. A typical CNN processes the convolution layer first, but a model provided in an embodiment applies a pooling layer first and then is delivered data to a convolution layer. The main reason for this approach is that the pooling layer allows for down-sampling of the feature map, thereby reducing memory usage. Moreover, this approach allows feature extraction as well as memory optimization.

In an embodiment, the pooling layer from the input data delivers data to the convolution layer by using an 8×8 kernel. The convolution layer generates a feature composed of 16 channels by using a 5×5 kernel. Afterwards, these features are delivered to two fully-connected layers, which generate 13 outputs representing spike rates for the given event data.

In an embodiment, it is recognized that a conventional SNN is not optimized for requirements (low power consumption, real-time inference, and efficient distribution on a real neuromorphic chip) required for autonomous driving when being designed for other applications. To effectively implement driver motion recognition for autonomous driving, there is a need for a neural network (simple but not performance-compromising) optimized for neuromorphic hardware and an event-driven dataset for training this neural network. In an embodiment, to address these elements, the issues are treated by designing, implementing, and testing a network that considering these features.

### Experiments and Results

### Event-Driven Camera and Data Conversion

Metavision EVK4 camera of Prophesee is one of the latest event-based vision sensors supporting 1280×720 resolution. Typically, when a change in pixel value exceeds a user-defined threshold, an event-based camera asynchronously detects a change in brightness and generates a specific event for the corresponding pixel. Each event includes location information at coordinates (x, y) representing a motion change, and a timestamp when an event occurs. The device offers a high dynamic range (86 dB, capable of exceeding 120 dB in low-light environments). A typical minimum reading is 0.08 lux, and an average and maximum event rate is 1.06 giga event/second (Geps).

In experiments, to directly utilize spike data obtained from a high-resolution event-based camera without requiring additional resources, a task of modifying an extractor may be minimized. In this way, information about coordinates, an origin (a newly-implemented EVK4 feature), and timestamp may be fetched.

Moreover, in an embodiment, it is observed that the most meaningful portion of motion information included in within the center of a pixel region of 720×720. Therefore, an input event size is cropped to pixels of 720×720.

### Dataset

Over the past few years, a large number of gesture datasets captured using simple frame-based sensors is published. However, the importance of a DVS dataset is strongly advocated to advance event-based computer vision. Conventionally, the first labeled event-based neuromorphic vision sensor dataset generated by moving an image in a specific direction within a screen is introduced based on a MNIST digit recognition dataset. This dataset is later further developed, and a plurality of frame artifacts are removed by using a pan-tilt device.

It is shown that artificial motion generation for static images enables the generation of important output events in a neuromorphic system (e.g., a spiking neural network). However, it is observed that static image recognition is ineffective when an event-based vision sensor is used together. This is because the primary purpose of the sensor is focused on dynamic scenes.

After these shortcomings are recognized, a dataset consisting of dynamic scenes is presented. A neuromorphic dataset using the DAVIS camera output is developed by introducing a new dataset that transforms existing video benchmarks into a spiking neuromorphic dataset for object tracking and motion/object recognition.

The dataset shows a dynamic motion in a spiking neuromorphic fashion, but a DVS camera generates a temporal resolution output of a microsecond unit. On the other hand, data generated by an existing vision tool, such as a video recorder or a color camera, has a temporal resolution of a millisecond unit, which results in high temporal frequency information loss during conversion.

Furthermore, the existing tool is likely to include a lot of incidental and unnecessary artifacts during conversion. To address this issue, the DvsGesture dataset, which directly captures scenes with a DVS128 camera, is proposed.

Additionally, the DvsGesture dataset is captured under diverse lighting conditions. The reason is that the DVS sensor is less sensitive to brightness and introduces significant noise. However, the DvsGesture dataset is primarily used for simple classification tasks and may be substantially less practical.

### N-Driver Motion Dataset

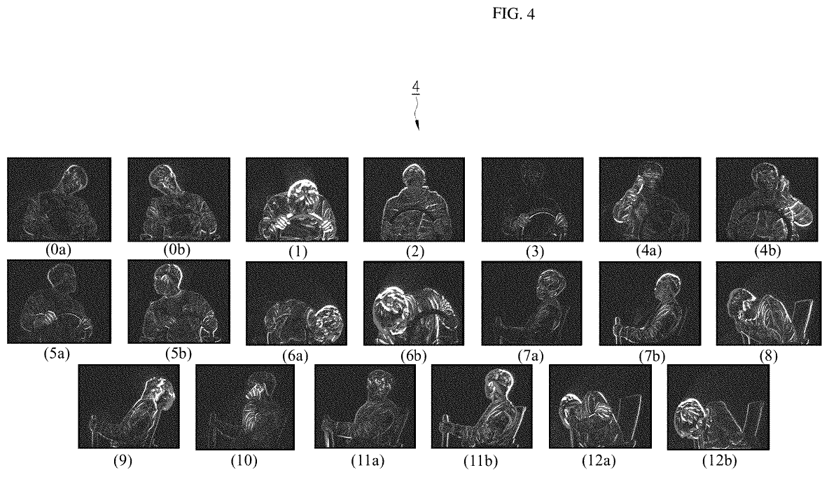

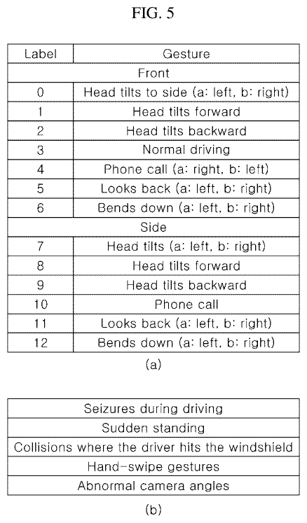

The N-Driver Motion dataset consists of 1,239 instances and includes 13 sets of driver motions (one normal driving motion and 12 potentially dangerous driving motions). This may be identified in the tables in FIGS. 4 and 5. FIG. 4 is a diagram showing a sample image captured for each driver gesture. These motions may include dropping a head (front, side, or back), using a mobile phone (a right hand or a left hand), looking back (a right side or a left side), and bending down (a right side or a left side). Moreover, all of the motions are captured by being shot from the side. The dataset is collected from 23 subjects under 3 different lighting conditions. All subjects are within a certain age range and have no disabilities or other issues. Each subject performed all 13 motions within a single recording, and each motion is recorded for approximately 3 seconds in the same brightness conditions.

The lighting conditions are categorized as “bright”, “moderate”, and “dark”.

This is done to examine the impact of lighting variability on the robustness of event data. In addition, informed consent is obtained from all subjects during a data collection process. Furthermore, to evaluate the performance of a classifier, 992 motions are randomly selected as a training set, and the remaining 247 motions are used as a test set.

Moreover, in an embodiment, five new types of event data that are not used in a training process are introduced to cover unpredictable scenarios. These additional test cases include seizures occurring during driving, which is caused by abnormal camera angles due to accidents or camera fixation issues, sudden standing or moving motions, accidents where a driver hits the windshield, and unusual reactions such as hand-swipe gestures. These newly generated event-based video sequences are specifically designed to test how a system reacts to other unusual cases not seen during training.

### Experimental Setup and Tool Flow

This experiment consists of three sub-experiments to measure the various performances of the proposed model. The goals of each sub-experiment are to measure the accuracy of classifying 13 driving motions, the accuracy of classifying unexpected and abnormal driving motions from normal driving motions, and the energy efficiency relative to a throughput according to various AI accelerators.

### 1) Multi-Driver Motion Classification

The purpose of this experiment is to observe how accurately the proposed system is capable of classifying various driver motions (13 classes in total). The model, which is developed based on Lava-DL API, is loaded onto an RTX 3080 GPU and is trained for 200 epochs.

At each epoch during training, the model is evaluated by using the test set, and the accuracy is calculated based on the spike rate of output spikes. When the highest test accuracy is calculated in a particular epoch, the weight of the corresponding model is stored as a PyTorch state dictionary file. Additional details about a system configuration are provided below.

### 2) Inference on Unexpected and Abnormal Driving Motions

It is important to identify the classification performance of the model based on a set of provided 13 motions, but it is also important to identify how well the model may respond to a new and unexpected motion set.

In this experiment, inference is performed on a separate dataset consisting of abnormal driver motions and normal driving motions that are not included in the 13 classes. The goal of this experiment is to perform binary classification. The goal is to distinguish between abnormal and normal driver motions.

Furthermore, in this experiment, in the case where the model generates a prediction other than label 3 (a normal driving motion) when an abnormal driver motion is given, the model may be determined to classify it as an abnormal motion. On the other hand, when a gesture is predicted as label 3, the model is considered to classify it as a normal motion.

This experiment utilizes a fully trained CSNN model with the same configuration (e.g., sampling time of event data, etc.) as the 13-motion classification task.

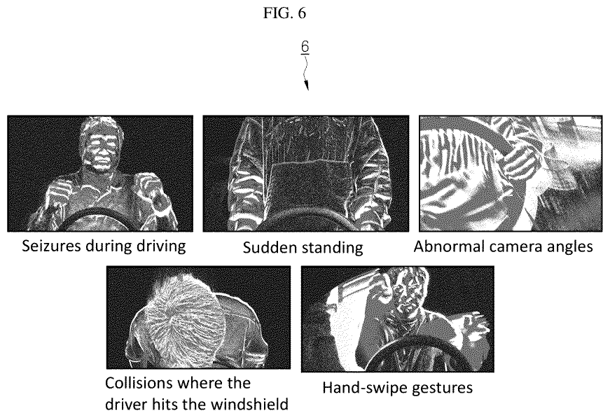

The test data for this experiment consisted of 82 abnormal driver motions (data obtained as 10 participants perform five unexpected abnormal driving motions (shown in FIG. 6 and the table in FIG. 5)) and 63 normal driving motions (fetched from an original test set).

FIG. 5 shows a table showing a label (a) of driver gestures and abnormal driver gestures (b). FIG. 6 shows sample images captured for abnormal driver gestures. This means that a hand-swipe gesture is not simply a hand-swipe motion, but a gesture for protecting oneself from various attacks.

The evaluation is performed in the same manner as multi-driver motion classification, but in this experiment, it is performed in a binary classification method.

### Energy Efficiency on Various AI Accelerators

Energy efficiency is one of the most promising aspects of spiking neural networks (SNNs). This experiment aims to demonstrate the overall efficiency of a model on three AI accelerators (Nvidia RTX 3080, Nvidia Jetson Xavier NX, and Intel Loihi 2).

In the case of Nvidia GPU, the model is directly loaded onto a device and measures inference costs (latency, total energy consumption, etc.). Due to the fast inference speed of the GPU, the total cost is divided by the number of processed samples to obtain an average.

In the case of Loihi 2, a specific pipeline is designed to load a model onto a system and to directly input event data into the model. In this process, a measurement tool provided by Lava API is utilized. Detailed information about the experimental flow and setup for Jetson Xavier NX and Loihi 2 is provided below.

### Network Configuration and Training

To facilitate proper training, a dataset is converted from a binary format to a tensor format. This tensor consists of an x-coordinate, a y-coordinate, a polarity, and a timestamp.

Moreover, the sampling time is set to 2.0 seconds. The reason is that most critical driving motions occur within this time. More importantly, it is determined whether the proposed model is capable of classifying driver motions in a short time. This meets requirement that the system needs to quickly detect abnormal activities in real-time applications. The converted data may be used as an input to a spiking CNN (CSNN) during runtime.

All applications are mapped and implemented on GPU/CPU through simulations for Loihi 2, and training is performed by using a software framework of Lava version 0.4.4 and a Lava-DL library.

The CSNN model is developed as a neuron model, and is trained as SLAYER API by using the event-based dataset provided by Lava-DL. Experiments are done with different CNN configurations and the accuracy results are compared with each other. Due to the high resolution of the dataset, each network is trained for 200 epochs with a single batch size of 1.

A CUBA Leaky Integrate-and-Fire (LIF) model is selected as a default neuron model for a spiking CNN model. Optimization is set to a learning rate of 3×10³, and an ADAM optimizer is used as an optimization tool.

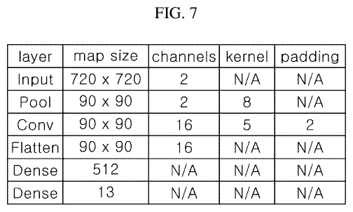

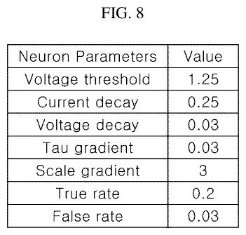

A spike rate loss is selected as a loss function. A four-layer CSNN network configuration and neuron parameters are presented in tables in FIGS. 7 and 8. FIG. 7 is a table illustrating a network configuration of a four-layer CSNN for a GPU. FIG. 8 is a table illustrating neuron parameter settings. Neuron parameters are set identically for both a GPU model and a Loihi 2 model.

### Edge Device Configuration and Inference

This paper provides a detailed description of various AI accelerators specifically designed for use on edge devices. In this example, the overall energy efficiency based on image processing latency is compared by using two edge AI accelerators: the Jetson Xavier NX and the Intel Loihi 2.

### 1) Jetson Xavier NX

The Jetson Xavier NX is a full-featured development board with a 6-core ARM CPU, 48-tensor core processing units supporting the clock frequency up to 1.1 GHZ, and a memory of 16 GB. To minimize power consumption, a task is performed on a standard module. In this mode, the clock frequency of the GPU is set to 0.67 GHz. All inference configurations are set to be the same as the RTX 3080, but only the library versions are different from each other. Due to Python version limitations, inference on Jetson Xavier NX is performed with a library of Lava-DL version 0.4.0.

### 2) Intel Loihi 2

A Neuromorphic chip is an edge AI accelerator specialized for implementing an SNN. Among various neuromorphic chips, the overall power consumption of a 3-layer fully connected SNN model and the proposed CSNN model is observed by using Loihi 2.

Loihi 2 adopts CUBA LIF as a default neuron model, which is found to be suitable for all proposed models.

### Loihi 2 Hardware Configuration

Oheo Gulch is used in this experiment. This is one of the Loihi 2-based neuromorphic systems, and is a system including a single Loihi 2 chip in a single socket. Due to the features of the input and model size and the limited availability of Loihi 2 chips, several adjustments were made to the input and the model.

### Input Adjustment

The input resolution is downsampled from 720×720 to 40×40 by using max pooling. The motion stream duration is reduced from 3.0 seconds to 1.7 seconds.

### Model Adjustment

There are no changes to the 3-layer fully connected layer model. The CUBA pooling layer is excluded because the input of the proposed CSNN model is already downsampled.

The number of extracted features was reduced from 16 to 4. The network model description for Loihi 2 is presented in Table 5.

### Model Load

The 3-layer fully connected layer model is loaded onto a single Loihi 2 chip. However, the proposed CSNN model requires greater hardware requirements and is loaded onto a total of four Loihi 2 chips.

### Inference Process on Loihi 2

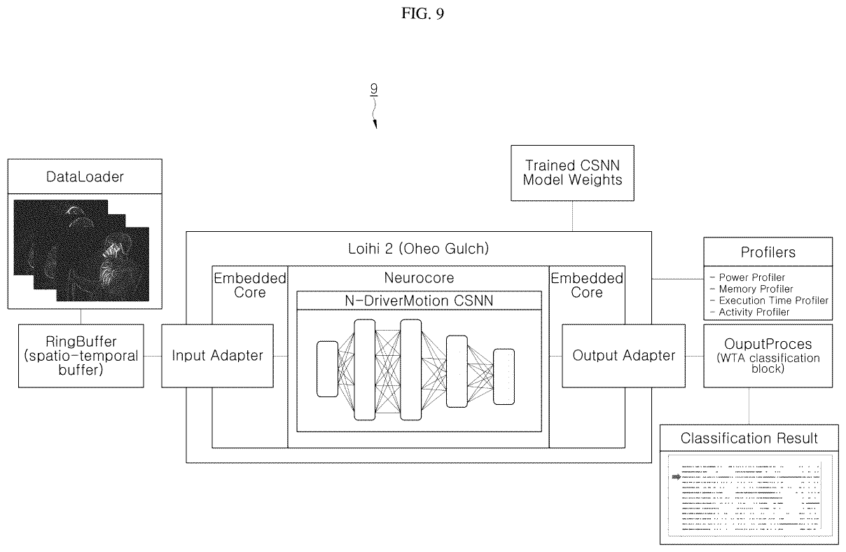

To perform inference on Loihi 2, a pipeline needed to be configured to utilize spatio-temporal data for classification tasks. To this end, a pipeline for performing inference on Loihi 2 is developed, and the process is illustrated in FIG. 9. FIG. 9 illustrates a pipeline for inference of CSNN on a Loihi 2 processor. Blocks highlighted in gray are those belonging to a main process, and green blocks are those not included in the main process. Event data is stored in a buffer block called RingBuffer, and frame data is delivered to Loihi 2 one at a time. When the frame data is delivered to the Loihi 2, a spike occurs in the last layer of a model to generate a classification result for a single frame. This spike is accumulated and stored in an OutputProcess block and remains until all frames of event data are processed. The final classification is performed in a Winner-Takes-All (WTA) method, and a class having the most spikes is determined as a predicted value.

### Model Conversion and Mapping to Oheo Gulch Hardware

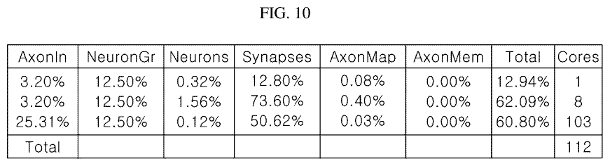

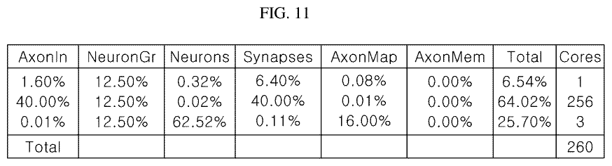

A full description of a process of converting and mapping a model to Oheo Gulch neuromorphic hardware is presented in the tables in FIGS. 10 and 11. Each column represents the percentage of total usage for input axons, neuron groups, neurons, synapses, axon mappings, and axon memory.

FIG. 10 is a table illustrating resource utilization of a 3-layer fully connected layer model on Loihi 2. FIG. 11 is a table illustrating resource utilization on Loihi 2 of the proposed CSNN model. The core utilization of the proposed model is more than twice that of the 3-layer fully connected layer model, which is due to the convolution layer operating as the bottleneck of the model.

### Results

### 1) Accuracy of 13 Class Prediction

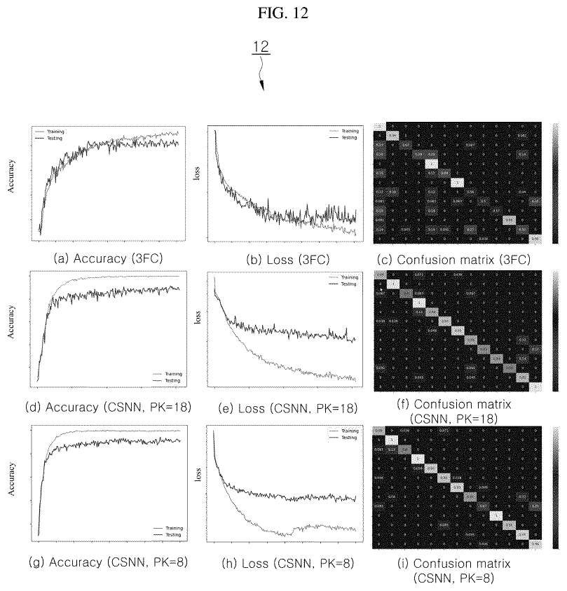

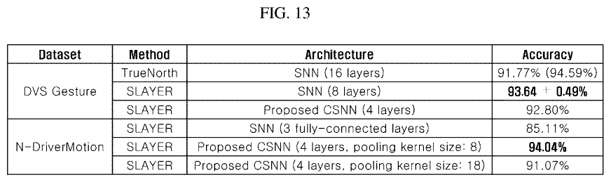

The results of the trained model classifying 13 driver motions are shown in the tables in FIGS. 12 and 13.

FIG. 13 a table for comparing classification results of a DVS Gesture dataset and an N-Driver Motion dataset. The DVS Gesture dataset includes results from SLAYER and IBM TrueNorth. The model proposed in both classification tasks demonstrates relatively high performance, and the overall accuracy difference is within less than 1.5% despite simpler model architecture.

The DVS Gesture recognition dataset is used as a benchmark dataset for model evaluation. This dataset consists of 11 hand gesture categories performed by 29 subjects under three lighting conditions. FIG. 12 is a diagram showing results (accuracy, loss, and confusion matrix) of the 3-layer fully connected layer SNN (3FC) and the proposed CSNN (PK=8 and a pooling kernel size of PK=18), according to an embodiment. In a confusion matrix, as the number of predictions for a label increases, color approaches white. Compared to a 3FC model, the proposed CSNN achieves faster convergence and higher overall accuracy.

### Configurations of Three Experimental SNN

SNN with all layers configured as dense connections.

SNN with one spiking convolutional layer and two fully connected layers (the pooling kernel size is set to 8).

SNN that is the same as Model 2, but a pooling kernel size is set to 18.

### Data Preprocessing and Experimental Environments

Motion stream: to classify motions of each class, only the first 2.0 seconds out of the 3-second motion stream are selected.

Temporal resolution: to improve training efficiency, the temporal resolution is set to 5 milliseconds.

### Evaluation Metrics and Recording Items

The following metrics are recorded for each experiment.

Accuracy and optimal loss of SNN (recorded for both the training and inference stages)

Confusion Matrix (confusion matrix for the corresponding inference results)

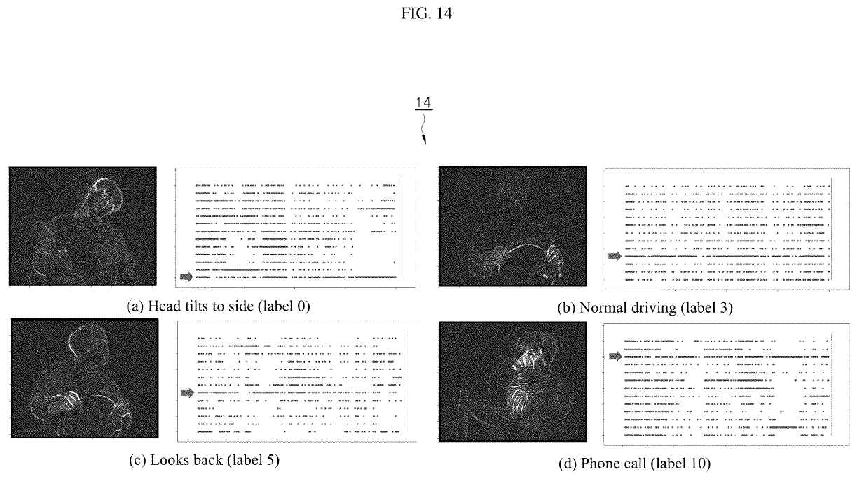

The confusion matrix shown in FIG. 12 shows that a normal situation (label 3) is clearly distinguished from a dangerous situation. FIG. 14 shows the classification results for 13 driver motions through output spikes captured in an output layer.

FIG. 14 is a diagram showing classification results according to a output spike generated at each timestamp. A model is observed to show superior classification performance by generating the most spikes corresponding to a ground truth label assigned to an event stream (Winner-Takes-All method).

### Performance of the Proposed CSNN Model

The proposed CSNN model consisting of four layers achieves the highest accuracy of 94.04% in the test. Because this model includes a pooling layer and a convolution layer, the accuracy of this model is more improved by approximately 8% than the accuracy of a model consisting of only three fully connected layers.

### Memory Limitations and Model Simplification

High-resolution event data may lead to out-of-memory issues, and thus the model is simplified by applying constraints to the model to solve the issues. Nevertheless, the model demonstrated competitive results.

### Dataset Differences

The dataset proposed in an embodiment needs to be classified into more categories, and there is a difference in that it does not include repetitive motions unlike the DVS gesture recognition dataset.

### 2) Accuracy of Unexpected Abnormal Driving Motion Classification Task

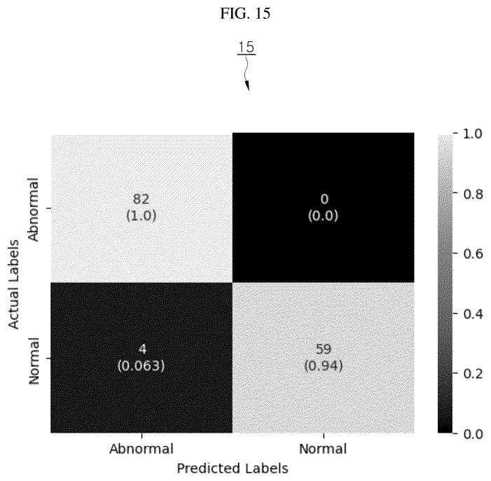

The binary classification results for unexpected abnormal motions and normal motions are shown in FIG. 15. The model may distinguish between two categories (normal and abnormal) with a high accuracy of 97.24%, excluding a case where four normal driving motions are incorrectly classified as abnormal motions. FIG. 15 is a diagram showing the classification results for unexpected abnormal driver motions.

A model demonstrates high sensitivity in detecting these motions, by accurately detecting all abnormal motions. It also classifies normal driver motions with high accuracy.

Most notably, there are no cases where an abnormal motion is misclassified as a normal motion. This result demonstrates the robust performance of the proposed CSNN model in detecting unexpected motions.

### 3) Latency and Energy Consumption

To measure the power consumption of the NVIDIA RTX 3080, an NVIDIA Management Library (NVML) is used. The throughput and energy consumption for single-event inference may be extracted through the library. Due to the fast inference time of a GPU, the average latency is calculated by dividing the total inference time by the total number of inference samples. Energy consumption is also measured by averaging the total energy consumption during the total inference time.

Unlike the GPU of RTX 3080, an Nvidia Jetson Xavier NX does not support the NVIDIA Management Library (NVML). To address the issues, a Jetson Stats library is used. The library records statistics by using a CSV file to track the energy consumption of the GPU.

Similarly to the RTX 3080, latency is calculated by dividing the total inference time by the total number of inference samples to calculate the average.

During inference, no additional GPU processes are performed except for a measurement process.

In the case of Loihi 2, a LAVA framework may obtain various measurement values related to power, execution time, the number of neurocore activities, and Neurocore SRAM utilization by supporting profiler tools.

To accurately measure latency and energy consumption, a profiler provides enough time to measure the overall cost by performing model one million times.

### Latency and Energy Comparison Experiments Between GPU and Loihi

Latency and energy comparison experiments between GPU and Loihi 2 are performed by using the same model, and the model is adjusted to be suitable for Loihi 2.

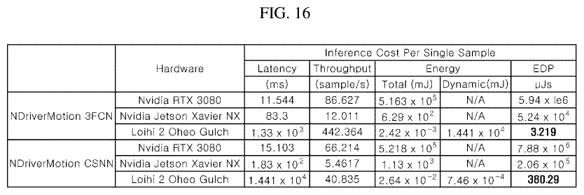

The results of various energy-related measurement values and a throughput for single-sample inference are shown in FIG. 9. The table in FIG. 16 shows the results of a comparison between GPU and Loihi 2 for single-sample inference costs. It is demonstrated that a Loihi 2 has high energy efficiency for the SNN model because EDP** of a Loihi 2 is significantly lower than both GPUs, even though a throughput of the RTX 3080 is lower.

### Energy Consumption Comparison

Loihi 2: a total of 1.82 J of energy is consumed during one million inferences. RTX 3080:500 joules of energy or more is required. Jetson Xavier NX: 1.13 joules of energy per inference is required. These results demonstrate that the Loihi 2 is highly energy efficient compared to the GPU.

### Throughput Comparison

Loihi 2 processes 40.835 samples per second. RTX 3080:66.214 samples per second are processed. Jetson Xavier NX: only 5.46 samples per second are processed, and a very low throughput is demonstrated. It is determined that the Loihi 2 has a low throughput because inference is performed by using only addition on input spike data, not matrix multiplication.

To compare the balance between fast execution time and low energy consumption of a device, the EDP is calculated. The EDP is measured by equally reflecting the performance of the device and energy consumption as weights. An EDP calculation method is performed by multiplying the total energy consumption for a single-sample inference by the latency.

### Comparison Result of EDP Between Loihi 2 and GPU

The Loihi 2 demonstrates better EDP than the GPU for both models (3FCN and CSNN).

### Compared to RTX 3080

The EDP of the 3FCN model is 1.8 million times more efficient than that of the RTX 3080. The EDP of the CSNN model is 20,721 times more efficient than that of the RTX 3080.

### Compared to Jetson Xavier NX

The EDP of the 3FCN model is 16,278 times more efficient than that of the Jetson Xavier NX. The EDP of the CSNN model is 541 times more efficient than that of the Jetson Xavier NX. These results demonstrate that the Loihi 2 is an efficient device that satisfies both low energy consumption and a fast execution time.

### Conclusion

In an embodiment, a novel event-based dataset called N-Driver Motion is proposed. This dataset is designed to learn and predict a driver's motion by using a neuromorphic vision system. In an embodiment, the system consists of an optimized CSNN capable of capturing the driver's motion as a spike input by using an event-based camera and efficiently inferring a 720×720 event stream without complex preprocessing.

### Features of N-Driver Motion Dataset

It consists of 13 driver motion categories. Classification is performed for each driving direction, each lighting condition, and each participant, and challenging environments such as low-light environments and tunnels are specifically included.

### Experimental Results

### Driver Motion Recognition Accuracy

The high accuracy of 94.04% is achieved. Excellent performance is demonstrated even under challenging conditions such as changing lighting or directional input. The CSNN with 4-layer architecture is designed to enable training and inference even on energy- and resource-constrained platforms.

### Anomalous Driver Motion Detection

The accuracy of 97.24% is achieved in distinguishing between unexpected abnormal motions and normal driving motions. In particular, all abnormal driving motions are successfully classified accurately. This indicates the high reliability of detecting various abnormal driving motions in real-world applications.

Comparison with DVS Gesture Recognition

The proposed system achieves competitive accuracy in an event vision system using an SNN and a DVS gesture recognition task. The efficiency of the system is demonstrated in that similar performance is achieved with simpler model architecture.

### Comparison of Energy Efficiency and EDP

Distributing the system on a Loihi 2 neuromorphic processor of Intel indicates high energy efficiency.

According to EDP results, it is 20,721 times more efficient than the RTX 3080. It is 541 times more efficient than the Jetson Xavier NX. This level of efficiency may be important for a real-time on-device AI application and may be applied even when power consumption is a critical constraint.

### Final Conclusion

This system eliminates time-consuming preprocessing and significantly reduces power consumption while maintaining high accuracy. Accordingly, it may improve the safety and efficiency of an autonomous driving system using a neuromorphic vision technology. Furthermore, the N-Driver Motion dataset may provide a valuable resource for future driver behavior prediction research. In particular, it will be helpful for an AI-based system that requires a high-resolution event dataset.

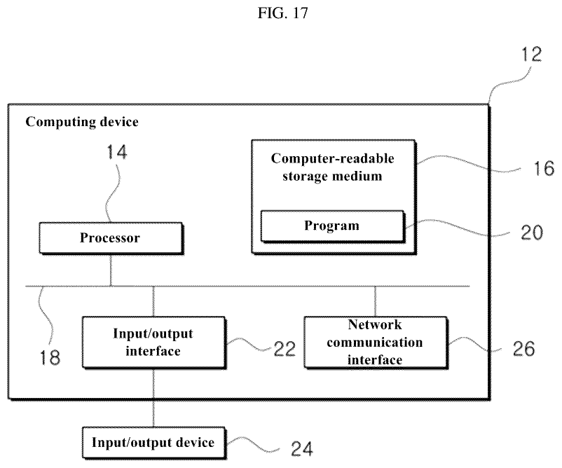

FIG. 17 is a block diagram illustrating a computing environment 10 including a computing device suitable for use, in embodiments. In the illustrated embodiment, each component may have different functions and capabilities in addition to those described below, and may include additional components in addition to those described below.

The illustrated computing environment 10 includes a computing device 12. In an embodiment, the computing device 12 may be an event-based driver motion recognition device using a Loihi 2-based convolutional spiking neural network for autonomous driving.

The computing device 12 includes at least one processor 14, a computer-readable storage medium 16, and a communication bus 18. The processor 14 may cause the computing device 12 to operate according to the aforementioned embodiment. For example, the processor 14 may execute one or more programs stored on the computer-readable storage medium 16. The one or more programs may include one or more computer-executable instructions. When executed by the processor 14, the computer-executable instructions may be configured to cause the computing device 12 to perform operations according to an embodiment.

The computer-readable storage medium 16 is configured to store computer-executable instructions, program code, program data, and/or other suitable forms of information. A program 20 stored on the computer-readable storage medium 16 includes a set of instructions executable by the processor 14. In an embodiment, the computer-readable storage medium 16 may be a memory (a volatile memory such as a random access memory, a non-volatile memory, or a suitable combination thereof), one or more magnetic disk storage devices, optical disc storage devices, flash memory devices, or any other form of storage media capable of storing desired information and accessed by the computing device 12, or a suitable combination thereof.

The communication bus 18 interconnects various components of the computing device 12, including the processor 14 and the computer-readable storage medium 16.

The computing device 12 may also include one or more input/output interfaces 22 that provide interfaces for one or more input/output devices 24, and one or more network communication interfaces 26. The input/output interface 22 and the network communication interface 26 are connected to the communication bus 18. The input/output device 24 may be connected to other components of the computing device 12 via the input/output interface 22. The input/output device 24 may include an input device such as a pointing device (such as a mouse or a trackpad), a keyboard, a touch input device (such as a touchpad or touchscreen), a voice or sound input device, various types of sensor devices, and/or a photographing device, and/or an output device such as a display device, a printer, a speaker, and/or a network card. The input/output device 24 may be included within the computing device 12 as a component constituting the computing device 12, or may be connected to the computing device 12 as a separate device distinct from the computing device 12.

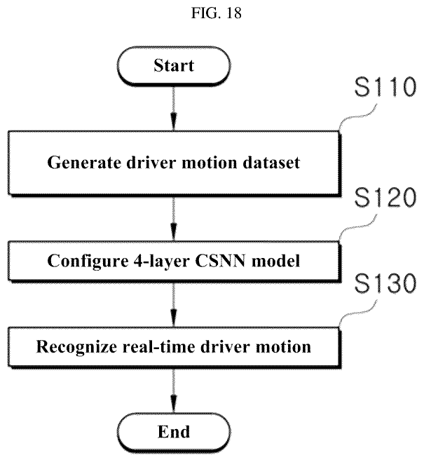

Hereinafter, FIG. 18 will be described. The contract automatic generation method illustrated in FIG. 18 may be performed by a driver motion recognition device including a processor.

In the meantime, FIG. 18 is merely an example, and the scope of the present disclosure is not limited to those illustrated in FIG. 18. For example, each step may be configured in a different order from that illustrated in FIG. 18; at least one of steps illustrated in FIG. 18 may not be performed; or, one or more steps not illustrated in FIG. 18 may be additionally performed.

Hereinafter, a driver motion recognition method of an event-based driver motion recognition device using a Loihi 2-based convolutional spiking neural network for autonomous driving will be sequentially described. An operation (function) of a method according to an embodiment is essentially the same as that of a system, and thus descriptions the same as those in FIGS. 1 and 2 will be omitted.

FIG. 18 is a flowchart illustrating a driver motion recognition method of an event-based driver motion recognition device using a Loihi 2-based convolutional spiking neural network for autonomous driving.

Referring to FIG. 18, in operation S110, event data of a certain resolution is recorded during for a certain period of time by using a camera, and an event-based driver motion dataset for training and validation of Loihi 2 chip-based CSNN is generated. In operation S120, the Loihi 2 chip-based CSNN is configured as a 4-layer CSNN model consisting of a 3D pooling layer, a 3D convolution layer, and two fully connected layers. In operation S130, a real-time driver motion is recognized through an event-based data processing method and a fast computational speed of a Loihi 2 chip.

Through an embodiment, a neuromorphic vision system achieves a competitive accuracy of 94.04% in a task of classifying 13 classes and achieves the accuracy of 97.24% in a task of classifying unexpected abnormal driver motions. Moreover, a driver monitoring system for edge devices requiring low-power and efficient neural network architectures or autonomous vehicles is developed to be safer and more efficient.

Furthermore, the proposed model provides 541 times higher efficiency than edge GPUs and 20,721 times higher efficiency than non-edge GPUs in terms of Energy Delay Product (EDP) on Loihi 2. Also, the motion of a driver may be predicted and recognized in real time by using a high-resolution event-based camera and an efficient CSNN.

Besides, early detection of abnormal driver motion enables immediate response by autonomous vehicles and ADAS, thereby significantly improving the safety of a driver and a pedestrian. Moreover, the irregular behavior of a driver may be classified at a high accuracy of 97.24%, thereby rapidly detecting dangerous situations such as drowsiness, inattention, and sudden movements during driving.

Furthermore, the proposed CSNN and the neuromorphic vision system operates 20, 721 times more efficiently on a Loihi 2 processor and dramatically reduces energy consumption in autonomous vehicles and edge devices through 541 times higher energy efficiency than an edge device-dedicated GPU, thereby implementing a low-power and highly-efficient AI system.

Also, a real-time driver motion recognition system may be performed in a low-power edge device, thereby ensuring a long operating time even in a battery-powered system. Besides, the proposed N-driver motion dataset contributes to a driver motion recognition research by providing high-resolution, event-based camera data with a resolution of 720×720.

In addition, an event-based dataset is obtained by categorizing a driver's motions into 13 driver motion categories based on lighting conditions (bright, normal, and dark) and participants as well as the driver's front and side motions. This enables learning in a wider variety of environments than existing datasets. Moreover, the proposed CSNN may have architecture capable of directly performing training without time-consuming preprocessing, thereby saving time required for data preprocessing.

Furthermore, an existing AI system trains large datasets and then transmits the trained result to individual vehicles. However, the system according to an embodiment of the present disclosure enables on-device learning and real-time inference, thereby recognizing the driver's motions directly within a vehicle. Also, when a real-time recognition system is applied to an edge device and the ADAS of an autonomous vehicle, latency may be significantly reduced by implementing the real-time recognition system.

Besides, a neuromorphic computing technology may be commercialized by developing a CSNN version optimized for an Intel Lava neuromorphic Framework and a Loihi 2 processor.

Moreover, the utility of next-generation AI hardware may be maximized by developing a CSNN optimized for next-generation neuromorphic hardware such as Loihi 2. Furthermore, the complexity of design and implementation may be reduced by proposing a simplified 4-layer CSNN, unlike conventional complex neural network architecture. Also, development costs for autonomous vehicles and edge devices may be reduced, and hardware resources and memory usage required during learning and inference may be reduced. Developers may achieve efficient development and maintenance by utilizing a neural network with simple architecture.

Besides, the driver motion recognition system may be integrated with a driver status monitoring (DSM) system, thereby enhancing the reliability of the assistance system of an autonomous vehicle. In addition, a support may be provided such that the autonomous driving system appropriately responds to driving situations, by early detecting the driver's abnormal motions (e.g., drowsy driving, inattention, etc.).

Moreover, a predictive autonomous driving decision-making system may be built thanks to the low latency and the high prediction accuracy of the event-based system, resulting in collision avoidance and accident prevention. Furthermore, a study on driver motion recognition using a high-resolution event camera and a spiking neural network is performed. This research significantly contributes to academic advancements in autonomous driving technology and edge AI.

Besides, an N-Driver Motion dataset creates a benchmark dataset capable of being utilized by researchers from academia and industry to develop and improve a driver recognition system.

In the meantime, methods according to the various embodiments of the present disclosure described above may be implemented in the form of applications or software programs that are capable of being installed on conventional electronic devices.

Furthermore, all or part of the method may consist of several software function modules and may be implemented in an operating system (OS). Alternatively, each step may consist of a single software function module, or each of these steps may be combined to form a software functional module and may be implemented on the operating system. Accordingly, it is understood that when a plurality of software function modules implement each step of the present disclosure and the plurality of software function modules are implemented on a single operating system, even though some embodiments of the present disclosure are not implemented entirely as a single software function module.

Moreover, the methods according to the various embodiments of the present disclosure described above may be implemented only through software or hardware upgrades to conventional electronic devices. Also, the various embodiments of the present disclosure described above may also be performed through an embedded server included in an electronic device, or an external server of the electronic device.

In the meantime, according to an embodiment of the present disclosure, the various embodiments described above may be implemented as software including instructions stored on a computer-readable recording medium by using software, hardware, or any combination thereof. In some cases, embodiments described herein may be implemented as a processor itself. In a software implementation, embodiments such as procedures and functions described herein may be implemented as separate software modules. Each software module may perform one or more functions and operations described herein.

In the meantime, a computer or a device similar thereto may be a device capable of recalling instructions stored in a storage medium and operating depending on the recalled instructions, and may include a device according to the disclosed embodiments. The instructions, when executed by a processor, may cause the processor to perform a function corresponding to the instructions, directly or by using other components under the control of the processor. The instructions may include the code generated or executed by a compiler or an interpreter.

A machine-readable recording medium may be provided in the form of a non-transitory computer-readable recording medium. Here, “non-transitory” means that a storage medium does not include a signal and is tangible, but does not distinguish between whether data is stored semi-permanently or temporarily on the storage medium. In this case, the non-transitory computer-readable medium refers to not a medium, which stores data for a short time, such as a register, a cache, a memory, or the like but a medium that stores data semi-permanently and is read by a device. Specific examples of non-transitory computer-readable medium include CDs, DVDs, hard disks, Bluray discs, USBs, memory cards, and ROMs.

As described above, embodiments are disclosed in drawings and specifications. While certain terms are used to describe embodiments herein, they are used solely to describe the technical ideas of the present disclosure and are not intended to limit meaning or to limit the scope of the present disclosure as recited in the patent claims. Therefore, it will be understood that various modifications and other equivalent embodiments are possible from this point by those skilled in the art. The technical protection scope of the present disclosure will be defined by the technical spirit of the appended claims.

According to an embodiment of the present disclosure, a neuromorphic vision system achieves a competitive accuracy of 94.04% in a task of classifying 13 classes and achieves the accuracy of 97.24% in a task of classifying unexpected abnormal driver motions.

Moreover, according to an embodiment of the present disclosure, a driver monitoring system for edge devices requiring low-power and efficient neural network architectures or autonomous vehicles is developed to be safer and more efficient.

Furthermore, according to an embodiment of the present disclosure, the proposed model provides 541 times higher efficiency than edge GPUs and 20,721 times higher efficiency than non-edge GPUs in terms of Energy Delay Product (EDP) on Loihi 2.

Also, according to an embodiment of the present disclosure, the motion of a driver may be predicted and recognized in real time by using a high-resolution event-based camera and an efficient CSNN.

Besides, according to an embodiment of the present disclosure, early detection of abnormal driver motion enables immediate response by autonomous vehicles and ADAS, thereby significantly improving the safety of a driver and a pedestrian.

Moreover, according to an embodiment of the present disclosure, the irregular behavior of a driver may be classified at a high accuracy of 97.24%, thereby rapidly detecting dangerous situations such as drowsiness, inattention, and sudden movements during driving.

Furthermore, according to an embodiment of the present disclosure, the proposed CSNN and the neuromorphic vision system operates 20,721 times more efficiently on a Loihi 2 processor and dramatically reduces energy consumption in autonomous vehicles and edge devices through 541 times higher energy efficiency than an edge device-dedicated GPU, thereby implementing a low-power and highly-efficient AI system.

Also, according to an embodiment of the present disclosure, a real-time driver motion recognition system may be performed in a low-power edge device, thereby ensuring a long operating time even in a battery-powered system.

Besides, according to an embodiment of the present disclosure, the proposed N-driver motion dataset contributes to a driver motion recognition research by providing high-resolution, event-based camera data with a resolution of 720×720.

In addition, according to an embodiment of the present disclosure, an event-based dataset is obtained by categorizing a driver's motions into 13 driver motion categories based on lighting conditions (bright, normal, and dark) and participants as well as the driver's front and side motions. This enables learning in a wider variety of environments than existing datasets.

Moreover, according to an embodiment of the present disclosure, the proposed CSNN may have architecture capable of directly performing training without time-consuming preprocessing, thereby saving time required for data preprocessing.

Furthermore, according to an embodiment of the present disclosure, an existing AI system trains large datasets and then transmits the trained result to individual vehicles. However, the system according to an embodiment of the present disclosure enables on-device learning and real-time inference, thereby recognizing the driver's motions directly within a vehicle.

Also, according to an embodiment of the present disclosure, when a real-time recognition system is applied to an edge device and the ADAS of an autonomous vehicle, latency may be significantly reduced by implementing the real-time recognition system.

Besides, according to an embodiment of the present disclosure, a neuromorphic computing technology may be commercialized by developing a CSNN version optimized for an Intel Lava neuromorphic Framework and a Loihi 2 processor.

Moreover, according to an embodiment of the present disclosure, the utility of next-generation AI hardware may be maximized by developing a CSNN optimized for next-generation neuromorphic hardware such as Loihi 2.

Furthermore, according to an embodiment of the present disclosure, the complexity of design and implementation may be reduced by proposing a simplified 4-layer CSNN, unlike conventional complex neural network architecture.

Also, according to an embodiment of the present disclosure, development costs for autonomous vehicles and edge devices may be reduced, and hardware resources and memory usage required during learning and inference may be reduced. Developers may achieve efficient development and maintenance by utilizing a neural network with simple architecture.

Besides, according to an embodiment of the present disclosure, the driver motion recognition system may be integrated with a driver status monitoring (DSM) system, thereby enhancing the reliability of the assistance system of an autonomous vehicle.

In addition, according to an embodiment of the present disclosure, a support may be provided such that the autonomous driving system appropriately responds to driving situations, by early detecting the driver's abnormal motions (e.g., drowsy driving, inattention, etc.).

Moreover, according to an embodiment of the present disclosure, a predictive autonomous driving decision-making system may be built thanks to the low latency and the high prediction accuracy of the event-based system, resulting in collision avoidance and accident prevention.

Furthermore, according to an embodiment of the present disclosure, a study on driver motion recognition using a high-resolution event camera and a spiking neural network is performed. This research significantly contributes to academic advancements in autonomous driving technology and edge AI.

Besides, according to an embodiment of the present disclosure, an N-Driver Motion dataset creates a benchmark dataset capable of being utilized by researchers from academia and industry to develop and improve a driver recognition system.

The effects that may be obtained from embodiments of the present disclosure are not limited to those mentioned above, and other effects not mentioned may be clearly derived and understood by those who skilled in the art to which the embodiments of the present disclosure belong from the following description. In other words, unintended effects of practicing the embodiments of the present disclosure may also be derived from the embodiments of the present disclosure by those who skilled in the art.

While the present disclosure has been described with reference to embodiments, it will be apparent to those skilled in the art that various changes and modifications may be made without departing from the spirit and scope of the present disclosure. Therefore, it should be understood that the above embodiments are not limiting, but illustrative.

What is claimed is:

1. A driver motion recognition device comprising:
a memory configured to store at least one instruction for event-based driver motion recognition by using a Loihi 2-based convolutional spiking neural network (CSNN) for autonomous driving; and
a processor configured to perform an operation according to the instruction,
wherein the processor is configured to:
generate an event-based driver motion dataset for training and verifying the Loihi 2 chip-based CSNN by recording event data of a specific resolution during a specific period of time by using a camera, and
wherein the Loihi 2 chip-based CSNN is a 4-layer CSNN model consisting of a 3D pooling layer, a 3D convolution layer, and two fully connected layers, and recognizes a real-time driver motion through an event-based data processing method and a fast computational speed of a Loihi 2 chip.

2. The driver motion recognition device of claim 1, wherein the dataset includes event data including information about an x-coordinate, an y-coordinate, a polarity, and an occurrence time, and includes 13 driver motions including one normal driving motion and twelve potentially-hazardous motions, 23 participants, and a lighting condition including bright, moderate, and dark.

3. The driver motion recognition device of claim 1, wherein the processor is configured to:
evaluate generalization performance of the Loihi 2 chip-based CSNN by including five types of abnormal event data that are not used in training.

4. The driver motion recognition device of claim 1, wherein the 3D pooling layer of the CSNN model reduces a size of input event data by using a 8×8 kernel and reduces memory usage,
wherein the 3D convolution layer of the CSNN model generates a feature map of 16 channels by using a 5×5 kernel, and
wherein the fully connected layer of the CSNN model generates a spike rate for each class of 13 output nodes through the two fully connected layers.

5. The driver motion recognition device of claim 1, wherein the CSNN trains a CSNN model with an N-Driver Motion dataset by using a surrogate gradient descent (SLAYER)-based backpropagation method.

6. The driver motion recognition device of claim 1, wherein the processor is configured to:
generate event data as a dataset by detecting a change amount of light; and
provide a temporal resolution, at which each pixel is capable of operating in a single frame, through the dataset.

7. The driver motion recognition device of claim 2, wherein the 13 driver motions include tilting a head to a side, tilting the head forward, tilting the head backward, using a mobile phone with a right hand, using the mobile phone with a left hand, looking back to a right, looking back to a left, bending down to a right, and bending down to a left.

8. The driver motion recognition device of claim 3, wherein the abnormal event data includes a seizure during driving, sudden standing, a collision where a driver hits a windshield, a hand-swipe gesture, and an abnormal camera angles due to an accident or a camera fixation issue.

9. The driver motion recognition device of claim 5, wherein the CSNN is built based on a spiking neural network (SNN) and directly trains a CSNN model by converting event data into a spike form.

10. The driver motion recognition device of claim 9, wherein the CSNN performs a 3D spiking convolution operation by using spatial information and time information of the event data.

11. A driver motion recognition method of an event-based driver motion recognition device using a Loihi 2 chip-based CSNN for autonomous driving, the method comprising:
generating an event-based driver motion dataset for training and verifying the Loihi 2 chip-based CSNN by recording event data of a specific resolution during a specific period of time by using a camera;
configuring the Loihi 2 chip-based CSNN as a 4-layer CSNN model consisting of a 3D pooling layer, a 3D convolution layer, and two fully connected layers; and
recognizing a real-time driver motion through an event-based data processing method and a fast computational speed of a Loihi 2 chip.

12. The method of claim 11, wherein the dataset includes event data including information about an x-coordinate, an y-coordinate, a polarity, and an occurrence time, and includes 13 driver motions including one normal driving motion and twelve potentially-hazardous motions, 23 participants, and a lighting condition including bright, moderate, and dark.

13. The method of claim 11, wherein the configuring of the Loihi 2 chip-based CSNN as the 4-layer CSNN model includes:
evaluating generalization performance of the Loihi 2 chip-based CSNN by including five types of abnormal event data that are not used in training.

14. The method of claim 11, wherein the 3D pooling layer of the CSNN model reduces a size of input event data by using a 8×8 kernel and reduces memory usage,
wherein the 3D convolution layer of the CSNN model generates a feature map of 16 channels by using a 5×5 kernel, and
wherein the fully connected layer of the CSNN model generates a spike rate for each class of 13 output nodes through the two fully connected layers.

15. The method of claim 11, wherein the configuring of the Loihi 2 chip-based CSNN as the 4-layer CSNN model includes:
training a CSNN model with an N-Driver Motion dataset by using a surrogate gradient descent (SLAYER)-based backpropagation method.

16. The method of claim 11, wherein the configuring of the Loihi 2 chip-based CSNN as the 4-layer CSNN model includes:
generating event data as a dataset by detecting a change amount of light; and
providing a temporal resolution, at which each pixel is capable of operating in a single frame, through the dataset.

17. The method of claim 12, wherein the 13 driver motions include tilting a head to a side, tilting the head forward, tilting the head backward, using a mobile phone with a right hand, using the mobile phone with a left hand, looking back to a right, looking back to a left, bending down to a right, and bending down to a left.

18. The method of claim 13, wherein the abnormal event data includes a seizure during driving, sudden standing, a collision where a driver hits a windshield, a hand-swipe gesture, and an abnormal camera angles due to an accident or a camera fixation issue.

19. The method of claim 15, wherein the CSNN is built based on a spiking neural network (SNN) and directly trains a CSNN model by converting event data into a spike form.

20. The method of claim 19, wherein the CSNN performs a 3D spiking convolution operation by using spatial information and time information of the event data.
